(19) United States
(12) Patent Application Publication
(10) Pub. No.: US 2025/0092249 A1
(43) Pub. Date: Mar. 20, 2025

(54) ALLOY MATERIAL OF POLYCARBONATE-POLYETHYLENE TEREPHTHALATE

(71) Applicant: NAN YA PLASTICS CORPORATION, Taipei City (TW)

(72) Inventors: Te-Chao Liao, Taipei City (TW); Wen-Cheng Yang, Taipei City (TW); Chun-Che Tsao, Taipei City (TW); Chia-Yen Hsiao, Taipei City (TW); Yueh-Shin Liu, Taipei City (TW)

(73) Assignee: NAN YA PLASTICS CORPORATION, Taipei City (TW)

(21) Appl. No.: 18/496,945

(22) Filed: Oct. 30, 2023

(30) Foreign Application Priority Data
Sep. 15, 2023 (TW) 112135229

(51) Int. Cl. C08L 67/03; C08K 5/05

(52) U.S. Cl. CPC C08L 67/03; C08K 5/05; C08K 2201/012; C08L 2205/08

(57) ABSTRACT

An alloy material of polycarbonate-polyethylene terephthalate includes the following components: a polycarbonate, a polyethylene terephthalate, a transesterification inhibitor, and a compatibilizer.

### CROSS-REFERENCE TO RELATED APPLICATION

This application claims the priority benefit of Taiwan application serial no. 112135229, filed on Sep. 15, 2023. The entirety of the above-mentioned patent application is hereby incorporated by reference herein and made a part of this specification.

### BACKGROUND OF THE INVENTION

### Field of the Invention

The invention relates to an alloy material of polycarbonate-polyethylene terephthalate.

### Description of Related Art

Polycarbonate (PC) has been widely used in fields such as home appliances and automobiles due to the excellent mechanical properties and good processing characteristics thereof. However, PC is a material with high carbon emissions, and the carbon emissions thereof are about 9 kg CO₂/kg to 9.5 kg CO₂/kg.

The carbon emissions of native polyethylene terephthalate (PET) are only 2.6 kg CO₂/kg to 3.0 kg CO₂/kg. Therefore, PET is an environmentally friendly plastic material. Moreover, PET is a material with a higher recycling rate among plastic materials, and the recycling source thereof is stable, and it is easy to distinguish various types of recycled PET according to the recycling source. In this way, PET of various colors (such as transparent, white, or other colors) may be recycled to be suitable for various processed products. Products made from recycled PET (r-PET) may further reduce the carbon footprint of manufacturing products.

### SUMMARY OF THE INVENTION

The invention provides a polycarbonate (PC)-polyethylene terephthalate (PET) alloy material having the advantages of high impact resistance strength and heat resistance, and the addition of PET may reduce the carbon emissions needed for manufacturing materials.

An alloy material of polycarbonate-polyethylene terephthalate of the invention includes the following components: a polycarbonate, a polyethylene terephthalate, a transesterification inhibitor, and a compatibilizer. The transesterification inhibitor includes at least one of a phosphite transesterification inhibitor and a phosphate transesterification inhibitor. The compatibilizer includes at least one of a maleic anhydride graft copolymer, an ethylene-methyl acrylate-glycidyl methacrylate copolymer, a polyolefin elastomer graft glycidyl methacrylate, a polyethylene graft glycidyl methacrylate, an acrylonitrile-butadiene-styrene graft glycidyl methacrylate. Based on a total weight of the alloy material, a weight percentage of the transesterification inhibitor is 0.5 wt % to 2 wt %, and a weight percentage of the compatibilizer is 6 wt % to 15 wt %.

Based on the above, by adding the transesterification inhibitor, the transesterification reaction between PET and PC may be inhibited, thereby reducing the by-products (water or alcohol) produced by the transesterification reaction that cause the PC-PET alloy material to crack. At the same time, via the addition of the compatibilizer, the compatibility between PC and PET may be improved to avoid the reduction in impact resistance strength caused by large-scale phase separation.

### DESCRIPTION OF THE EMBODIMENTS

Hereinafter, embodiments of the invention are described in detail. However, these embodiments are illustrative, and the disclosure of the invention is not limited thereto.

Herein, a range indicated by “one value to another value” is a general representation which avoids enumerating all values in the range in the specification. Therefore, the record of a specific numerical range covers any number within this numerical range and any smaller numerical range bounded by any number within that numerical range as if such any number and such smaller numerical ranges were expressly written in the specification.

Polycarbonate (PC) is a commonly used high-performance engineering plastic with many advantages, such as high strength, wear resistance, high transparency, heat resistance, chemical resistance, and weather resistance. Therefore, PC has been widely used in fields such as electronics, automobiles, construction, medical equipment. Although PC has many advantages, the carbon emissions needed to make PC and the unstable recycling sources of PC have resulted in products made using PC gradually failing to meet the needs of environmental protection. To alleviate the issue, in the disclosure, polyethylene terephthalate (PET) with relatively lower carbon emissions is kneaded/mixed with PC, and the resulting PC-PET alloy material not only retains the advantages of high impact resistance strength and heat resistance, but also has the advantage of being environmentally friendly.

In order to make the PC-PET alloy material have sufficiently excellent properties, in the process of manufacturing the PC-PET alloy material, in addition to adding PC and PET, other additives such as a transesterification inhibitor, a compatibilizer, a toughening agent, a lubricant, a crystallization inhibitor, and an antioxidant are also needed. In some embodiments, a colorant, a flame retardant, a synergist, an anti-drip agent, etc. may also be added to the PC-PET alloy material. The various components in the PC-PET alloy material are described below.

### Polycarbonate (PC)

PC may include native PC, recycled PC, or a combination thereof. The native PC is generally existing new PC. The recycled PC may be physically regenerated PC. In some embodiments, based on the total weight of the final synthesized PC-PET alloy material, the weight percentage of PC is 30 wt % to 50 wt %.

### Polyethylene Terephthalate (PET)

PET may include native PET, recycled PET, or a combination thereof. The native PET is generally existing new PET. The recycled PET may include physically regenerated PET and/or chemically regenerated PET.

For example, the method of obtaining recycled PET includes collecting various types of waste polyester resin materials. The waste polyester resin material is classified according to type, color, and use. Furthermore, the waste polyester resin material is compressed and packed, and then transported to a waste treatment plant.

In some embodiments, the waste polyester resin material is recycled PET bottles, film materials, fibers, etc., but the invention is not limited thereto. Other members on the waste polyester resin material (such as bottle caps, labels, and adhesives of PET bottles) are removed. Next, the waste polyester resin material is cut and crushed to obtain a processed recycled polyester material (i.e., recycled polyethylene terephthalate (r-PET)) to facilitate subsequent manufacturing processes.

In the continuous process, the crushed r-PET fragments are then melted at high temperature in an extruder to form r-PET melt material. The extruder may include a single-screw extruder, a twin-screw extruder, a planetary extruder, etc.

The r-PET melt material then enters a pressure-controlled liquid thickening extrusion system in the continuing process. In this extrusion system, the material may be heated to a temperature of 230° C. to 300° C. under a low air pressure of 1 millibar (mbar) to 6 mbar for a duration of 15 minutes to 60 minutes, thus achieving the effect of increasing the intrinsic viscosity of the r-PET melt material and forming a recycled polyester resin. The recycled polyester resin (i.e., r-PET) has an intrinsic viscosity (IV) of 0.6 dL/g to 0.86 dL/g.

In some embodiments, the intrinsic viscosity of r-PET is controlled to optimize the subsequent manufacturing process of the PC-PET alloy material.

The material properties of the r-PET may be modified by a modified extruder in the continuing process.

Modifiers such as a transesterification inhibitor and a compatibilizer are first mixed evenly according to the proportion then enter the modified extruder in proportion using a loss-in-weight feeder, and are mixed with the recycled polyester resin in the molten state to form a physically recycled modified polyester particle with different functions. Modified extruder types include a single-screw extruder, a twin-screw extruder, a planetary extruder, etc. In some embodiments, in addition to modification with the transesterification inhibitor and the compatibilizer, a toughening agent, a lubricant, a crystallization inhibitor, an antioxidant, etc. are also added to the modification extruder to modify the r-PET.

In some embodiments, based on the total weight of the final synthesized PC-PET alloy material, the weight percentage of PET is 50 wt % to 70 wt %. In general, PET has less carbon emissions and a stable recycling source. Therefore, in order to improve environmental friendliness, it is better to make the content of PET in the PC-PET alloy material greater than the content of PC.

### Transesterification Inhibitor

When kneading/mixing PC and PET, a transesterification reaction may occur between PC and PET. The by-products (water or alcohol) produced by the transesterification reaction cause the polyester to crack, and lead to issues such as reduced molecular weight, deterioration, embrittlement (reduced impact resistance) of the material, causing both PC and PET to lose good mechanical properties.

In order to avoid excessive transesterification reaction, it is necessary to add an appropriate amount of a transesterification inhibitor when kneading/mixing PC and PET. The transesterification inhibitor includes, for example, at least one of a phosphite transesterification inhibitor and a phosphate transesterification inhibitor. The phosphite transesterification inhibitor is, for example, triphenyl phosphite, bis(2,4-dicumylphenyl) pentaerythritol diphosphite, tris(2,4-di-tert-butylphenyl) phosphite, and the phosphate transesterification inhibitor is, for example, sodium dihydrogen phosphate, disodium hydrogen phosphate, disodium dihydrogen pyrophosphate, triphenyl phosphate.

Adding too much or too little of the transesterification inhibitor has a negative impact on the subsequent PC-PET alloy material produced. Based on the total weight of the PC-PET alloy material, the weight percentage of the transesterification inhibitor is 0.5 wt % to 2 wt %, and 0.5 wt % to 1 wt % is preferred. When the weight percentage of the transesterification inhibitor is less than 0.5 wt %, excessive transesterification reaction occurs between PC and PET, resulting in poor heat resistance and processability of the PC-PET alloy material. When the weight percentage of the transesterification inhibitor is greater than 2 wt %, the compatibility between PET and PC is poor and the issue of reduced impact-resistance strength occurs. In addition, excess transesterification inhibitors increase costs.

### Compatibilizer

A compatibilizer may be used to improve the compatibility between PC and PET, thereby controlling the dispersion size of PC and PET. For example, one of PC and PET is the parent phase, and the other is the dispersed phase, wherein the compatibilizer helps to disperse the dispersed phase more evenly in the parent phase, thus preventing the separation of the two phases.

Via the combination of the transesterification inhibitor and the compatibilizer, the compatibility between PC and PET may be improved while avoiding by-products produced by the transesterification reaction. An appropriate amount of the compatibilizer is desired. The compatibilizer includes, for example, a maleic anhydride graft copolymer (such as at least one of maleic anhydride graft polyethylene (PE-MA), maleic anhydride graft polypropylene (PP-MA), maleic anhydride graft acrylonitrile-butadiene-styrene (ABS-MA), ethylene-methyl acrylate copolymer (E-MAC), ethylene-methyl acrylate-glycidyl methacrylate copolymer (E-MA-GMA), polyolefin elastomer graft glycidyl methacrylate (POE-g-GMA), polyethylene graft glycidyl methacrylate (PE-g-GMA), acrylonitrile-butadiene-styrene graft glycidyl methacrylate (ABS-g-GMA)).

Adding too much or too little of the compatibilizer has a negative impact on the subsequent PC-PET alloy material produced. Based on the total weight of the PC-PET alloy material, the weight percentage of the compatibilizer is 6 wt % to 15 wt %, and 8 wt % to 12 wt % is preferred. When the weight percentage of the compatibilizer is less than 6 wt %, the compatibility between PC and PET is poor, causing PC and PET to readily phase separate. When the weight percentage of the compatibilizer is greater than 15 wt %, although the impact-resistance strength and toughness of the material may be significantly improved, since the compatibilizer is an elastomer-like material, the tensile strength, flexural strength, and heat-resistant temperature are significantly reduced.

### Toughening Agent

A toughening agent may be used to improve the impact resistance strength of the PC-PET alloy material. For example, the toughening agent may be used to improve the impact resistance strength of the parent phase in the PC-PET alloy material. In some embodiments, in the PC-PET alloy material, the parent phase is PET and the dispersed phase includes PC.

In some embodiments, the toughening agent includes at least one of polyolefin elastomer (POE), acrylics (ACR), methyl acrylate-butadiene-styrene copolymer (MBS), ethylene-butyl acrylate-glycidyl methacrylate copolymer (PTW), or other suitable materials.

In some embodiments, based on the total weight of the PC-PET alloy material, the weight percentage of the toughening agent is 1 wt % to 5 wt %, wherein 2 wt % to 3 wt % is preferred.

### Lubricant

A lubricant may improve the fluidity of the material. Adding the lubricant to the PC-PET alloy material may facilitate the application of the PC-PET alloy material in the injection processing process and the release process of mold molding.

In some embodiments, the lubricant includes at least one of stearate, polyethylene wax, silicone modifier, and fluorine-based resin, or other suitable materials.

In some embodiments, based on the total weight of the PC-PET alloy material, the weight percentage of the lubricant is 0.1 wt % to 2 wt %, wherein 0.5 wt % to 1 wt % is preferred.

### Crystallization Inhibitor

A crystallization inhibitor is used to reduce the crystallization rate of PET. Generally, since PC is an amorphous plastic, if the crystallinity of PET is too high, when kneading/mixing PC and PET, the two phases are separated due to the incompatibility between the crystalline phase and the amorphous phase. By reducing the crystallization rate of PET via the crystallization inhibitor, PET with poor crystallinity or even amorphousness may be obtained, thus avoiding the phase separation issue.

In some embodiments, the crystallization inhibitor includes at least one of polyester modified by isophthalic acid (IPA) copolymerization (such as PET modified by 20% IPA copolymerization, i.e., IPET), polyester modified by cyclohexanedimethanol (CHDM) copolymerization, and other suitable materials, wherein the polyester modified by CHDM copolymerization is, for example, polyethylene glycol terephthalate modified by CHDM copolymerization (polyethylene terephthalate glycol-modified, PETG) or polyethylene cyclohexanedimethanol terephthalate (PCTG) modified by CHDM copolymerization.

In some embodiments, based on the total weight of the PC-PET alloy material, the weight percentage of the crystallization inhibitor is greater than or equal to 0 wt % and less than or equal to 5 wt %.

### Antioxidant

In some embodiments, the antioxidant includes at least one of a phenolic antioxidant, a mixed antioxidant, and a phosphite antioxidant.

In some embodiments, based on the total weight of the PC-PET alloy material, the weight percentage of the antioxidant is 0.5 wt % to 2 wt %.

The invention also proposes a product made from the PC-PET alloy material as an engineering plastic particle via a processing method. The processing method may include extrusion molding, injection molding, mold molding, or plate processing.

The PC-PET alloy material of the invention is described in detail below via experimental examples. However, the following experimental examples are not intended to limit the invention.

### Experimental Examples

The r-PET polyester particle was modified using the transesterification inhibitor, the compatibilizer, the toughening agent, the lubricant, the crystallization inhibitor, and the antioxidant to obtain a first modified r-PET polyester particle. The first modified r-PET polyester particle included 86.5 wt % r-PET (IV is 0.8), 8 wt % compatibilizer (E-MA-GMA), 2 wt % toughening agent (POE), 1 wt % crystallization inhibitor (PET modified by 20% isophthalic acid copolymerization), 0.5 wt % lubricant (polyethylene wax), 1 wt % transesterification inhibitor (phosphite, e.g., tris(2,4-di-tert-butylphenyl)phosphite), and 1 wt % antioxidant (mixed antioxidant). Then, the first modified r-PET polyester particle and PC were mixed in different proportions to obtain the alloy materials of PC-PET of Example 1 and Example 2 in Table 1. Moreover, Formosa Chemicals & Fibre acrylonitrile-butadiene-styrene (ABS) (AG12A0) was provided as Comparative example 1, and the alloy material of PC-PET obtained by mixing the first modified r-PET polyester particle and PC without using the transesterification inhibitor, the compatibilizer, the toughening agent, the lubricant, the crystallization inhibitor, and the antioxidant was provided as Comparative example 2 and Comparative example 3. Various property tests were performed on Comparative Example 1 to Comparative Example 3 and Example 1 to Example 2, and the results obtained are shown in Table 1.

TABLE 1

| | | Comparative | Comparative | Comparative | | |
|---|---|---|---|---|---|---|
| | | example 1 | example 2 | example 3 | Example 1 | Example 2 |
| PC (such as Formosa Idemitsu, A-1900) | | Formosa | 60 | 45 | 50 | 35 |
| r-PET (IV 0.8) | | Chemicals & | 40 | 55 | | |
| First modified r-PET polyester particle | | Fibre, ABS | | | 50 | 65 |
| | | AG12A0 | | | | |
| Actual r-PET content (wt %) | | 0 | 40 | 55 | 43.3 | 56.2 |
| Mechanical | Specific gravity | 1.05 | 1.24 | 1.27 | 1.24 | 1.27 |
| properties | Impact-resistance strength | 15.4 | 6.3 | 4.7 | 30.1 | 23.6 |
| | Tensile strength (MPa) | 44.6 | 54.7 | 51.3 | 53.4 | 52.6 |
| | Bending strength (MPa) | 73.3 | 74.5 | 72.6 | 77.2 | 75.3 |
| | Bending modulus (MPa) | 2,330 | 2,280 | 2,190 | 2,190 | 2,070 |
| | HDT (1.82 MPa) | 82 | 81 | 79 | 86 | 83 |
| Molding | Shrinkage (%) | 0.55 | 0.59 | 0.61 | 0.58 | 0.59 |

It may be known from Table 1 that the alloy material of PC-PET obtained by mixing modified r-PET polyester particle with PC has higher impact resistance strength and higher heat deflection temperature (HDT). In other words, the alloy materials of PC-PET of Example 1 and Example 2 have better mechanical strength and thermal stability.

Table 2 provides alloy materials of PC-PET obtained by mixing the second modified r-PET polyester particle or the third modified r-PET polyester particle with PC of some embodiments of the invention. The second modified r-PET polyester particle included the following materials: the modified r-PET polyester particle included 86.5 wt % r-PET (IV is 0.8), 8 wt % compatibilizer (ethylene-methyl acrylate copolymer, E-MA), 2 wt % toughening agent (POE), 1 wt % crystallization inhibitor (PET modified by 20% isophthalic acid copolymerization), 0.5 wt % lubricant (polyethylene wax), 1 wt % transesterification inhibitor (phosphite, e.g., tris(2,4-di-tert-butylphenyl)phosphite), and 1 wt % antioxidant (mixed antioxidant).

The third modified r-PET polyester particle included the following materials: the modified r-PET polyester particle included 86.5 wt % r-PET (IV is 0.8), 8 wt % compatibilizer (POE-g-GMA), 2 wt % toughening agent (POE), 1 wt % crystallization inhibitor (PET modified by 20% isophthalic acid copolymerization), 0.5 wt % lubricant (polyethylene wax), 1 wt % transesterification inhibitor (phosphite, tris(2,4-di-tert-butylphenyl)phosphite), and 1 wt % antioxidant (mixed antioxidant).

TABLE 2

| | | Example 3 | Example 4 | Example 5 | Example 6 |
|---|---|---|---|---|---|
| PC (such as Formosa Idemitsu, A- | | 60 | 45 | 50 | 35 |
| 1900) | | | | | |
| Second modified r-PET polyester | | 50 | 65 | | |
| particle | | | | | |
| Third modified r-PET polyester | | | | 50 | 65 |
| particle | | | | | |
| Actual r-PET content (wt %) | | 43.3 | 56.2 | 43.3 | 56.2 |
| Mechanical | Specific gravity | 1.24 | 1.27 | 1.24 | 1.27 |
| properties | Impact resistance | 10.3 | 9.7 | 12.7 | 10.9 |
| | strength | | | | |
| | Tensile strength | 55.2 | 53.2 | 53.0 | 51.9 |
| | (MPa) | | | | |
| | Bending strength | 72.6 | 73.2 | 76.1 | 75.8 |
| | (MPa) | | | | |
| | Bending modulus | 2,220 | 2,200 | 2,210 | 2,120 |
| | (MPa) | | | | |
| | HDT (1.82 MPa) | 79 | 77 | 81 | 79 |
| Molding | Shrinkage (%) | 0.58 | 0.60 | 0.59 | 0.59 |

It may be seen from Table 2 that the alloy materials of PC-PET of Examples 5 and 6 have higher impact resistance strength and higher bending strength than the alloy materials of PC-PET of Examples 3 and 4. It may be seen that the third modified r-PET polyester particle may more effectively improve the impact resistance strength and the bending strength of the alloy material of PC-PET.

What is claimed is:

1. An alloy material of polycarbonate-polyethylene terephthalate, comprising the following components:
a polycarbonate;
a polyethylene terephthalate;
a transesterification inhibitor comprising at least one of a phosphite transesterification inhibitor and a phosphate transesterification inhibitor; and
a compatibilizer comprising at least one of a maleic anhydride graft copolymer, an ethylene-methyl acrylate-glycidyl methacrylate copolymer, a polyolefin elastomer graft glycidyl methacrylate, a polyethylene graft glycidyl methacrylate, an acrylonitrile-butadiene-styrene graft glycidyl methacrylate, wherein based on a total weight of the alloy material, a weight percentage of the transesterification inhibitor is 0.5 wt % to 2 wt %, and a weight percentage of the compatibilizer is 6 wt % to 15 wt %.

2. The alloy material of polycarbonate-polyethylene terephthalate of claim 1, further comprising a toughening agent, wherein the toughening agent comprises at least one of a polyolefin elastomer, an acrylate, a methyl acrylate-butadiene-styrene copolymer, an ethylene-butyl acrylate-glycidyl methacrylate copolymer.

3. The alloy material of polycarbonate-polyethylene terephthalate of claim 2, wherein a weight percentage of the toughening agent is 1 wt % to 5 wt % based on the total weight of the alloy material.

4. The alloy material of polycarbonate-polyethylene of claim 1, further comprising a crystallization inhibitor, wherein the crystallization inhibitor comprises at least one of an isopropyl alcohol and a polyester modified by cyclohexane dimethanol copolymerization.

5. The alloy material of polycarbonate-polyethylene terephthalate of claim 4, wherein a weight percentage of the crystallization inhibitor is greater than 0 wt % and less than or equal to 5 wt % based on the total weight of the alloy material.

6. The alloy material of polycarbonate-polyethylene terephthalate of claim 1, further comprising a lubricant, wherein the lubricant comprises at least one of a stearate, a polyethylene wax, a siloxane modifier, and a fluorine resin.

7. The alloy material of polycarbonate-polyethylene terephthalate of claim 6, wherein a weight percentage of the lubricant is 0.1 wt % to 2 wt % based on the total weight of the alloy material.

8. The alloy material of polycarbonate-polyethylene terephthalate of claim 1, further comprising an antioxidant, wherein the antioxidant comprises at least one of a phenolic antioxidant, a mixed antioxidant, and a phosphite antioxidant.

9. The alloy material of polycarbonate-polyethylene terephthalate of claim 8, wherein a weight percentage of the antioxidant is 0.5 wt % to 2 wt % based on the total weight of the alloy material.

10. The alloy material of polycarbonate-polyethylene terephthalate of claim 1, wherein an intrinsic viscosity of the polyethylene terephthalate is 0.6 to 0.86, and a content of the polyethylene terephthalate in the alloy material of polycarbonate-polyethylene terephthalate is greater than a content of the polycarbonate.
